(19) United States
(12) Patent Application Publication
(10) Pub. No.: US 2010/0169892 A1
(43) Pub. Date: Jul. 1, 2010

(54) Processing Acceleration on Multi-Core Processor Platforms

(75) Inventors: Darrell Stam, Hollis, NH (US); Hans Graves, Nashua, NH (US)

Correspondence Address: HAMILTON & TERRILE, LLP - AMD, P.O. BOX 203518, AUSTIN, TX, 78720, US

(73) Assignee: ADVANCED MICRO DEVICES, INC., Sunnyvale, CA (US)

(21) Appl. No.: 12/344,882

(22) Filed: Dec. 29, 2008

(51) Int. Cl. G06F 9/50

(52) U.S. Cl. 718/105

(57) ABSTRACT

Embodiments disclosed herein include an accelerator module that modifies a single application to run on multiple processing cores of a single CPU. In one aspect, the application performs a task that includes some parallel operations and some serial operations. The parallel tasks may be run on different cores concurrently. In addition, serial tasks may be broken up to execute among different cores simultaneously without errors. In a particular embodiment, a FFMPEG decoding application is modified by the accelerator module to execute on multiple cores and perform video decoding in real time or faster than real time.

### TECHNICAL FIELD

Embodiments as disclosed herein are in the field of multi-core processing systems.

### BACKGROUND

Many modern central processing units (CPUs) are actually multiple CPUs in one integrated circuit package. This provides the advantage of more available computation hardware. The operating system (OS) manages the multiple cores in terms of allocating work to each of the cores. However, in many instances, all of the available cores are not most efficiently used. FIG. 1 is a block diagram of a prior art multi-core system including a CPU 102 with multiple cores 1 through 4. CPU 102 is coupled to a memory subsystem 104, which can include any type of memory that is directly accessible to the CPU 102 for the purpose of accessing and executing application code, managing cache and so on. CPU 102 is coupled to other system components via one or more buses 106 in any typical manner. Memory subsystem 104 stores multiple software applications (also referred to as programs or executables), application A, application B, and application C. Examples of applications include Microsoft (MS) Internet Explorer™, MS Outlook™, and many others. These applications are merely examples. Many more applications can be accessible to the CPU 102. In addition, applications and other executable code are accessible to CPU 102 remotely through bus 106 in some instances.

The arrow from application 1 to core 1 indicates that the CPU 102 has configured core 1 to execute application A. At the same time core 2 is configured to execute application B. Application C is executing on core 3. Core 4 is idle. This is an illustration of a typical manner of distributing work among various cores. While this is more efficient than a single-core system, some cores may be underused, or completely unused for significant periods of time. It would be desirable to provide a method for current multi-core systems to operate with less idle time for all of the available cores without requiring significant redesign to the CPU or cores.

### BRIEF DESCRIPTION OF THE DRAWINGS

FIG. 1 is a diagram of prior art multi-core processing system;

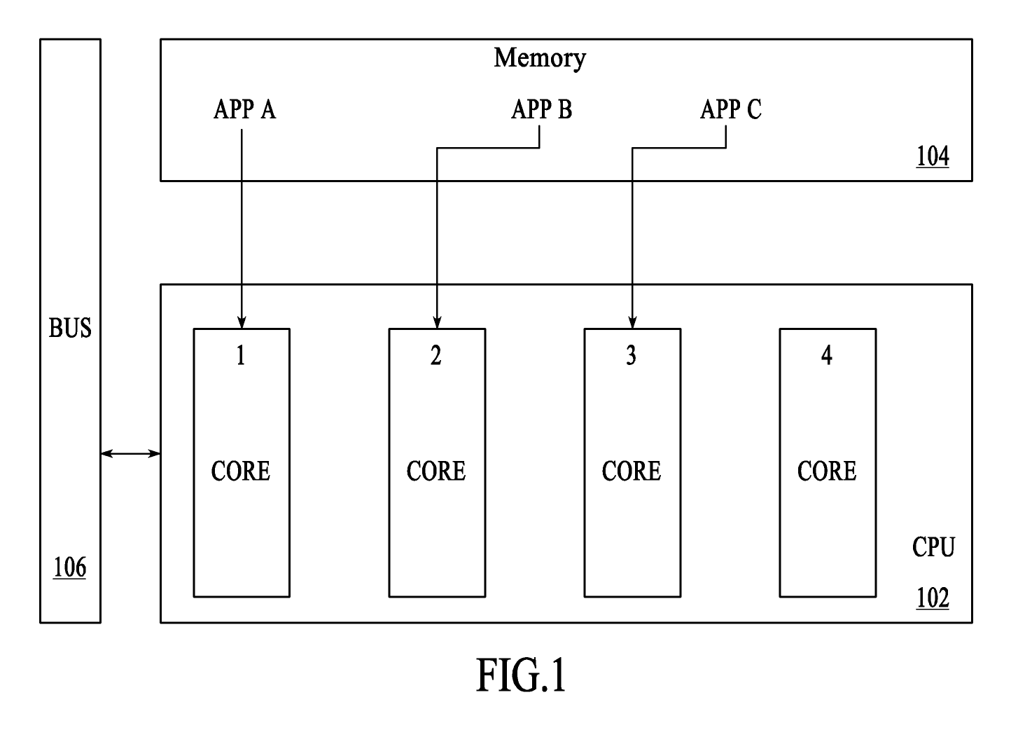

FIG. 2 is a block diagram of various components of a multi-core system and acceleration module according to an embodiment; and

FIG. 3 is a block diagram illustrating a flow of parsing, weighting and scheduling workloads according to an embodiment.

The drawings represent aspects of various embodiments for the purpose of disclosing the invention as claimed, but are not intended to be limiting in any way.

### DETAILED DESCRIPTION

Embodiments disclosed herein include an accelerator module that modifies a single application to run on multiple processing cores of a single CPU. In one aspect, the application performs a task that includes some parallel operations and some serial operations. The parallel task may be run on different cores concurrently. In addition, serial tasks may be broken up to execute among different cores simultaneously without errors. In a particular embodiment, a FFMPEG decoding application is modified by the accelerator module to execute on multiple cores and perform video decoding in real time or faster than real time.

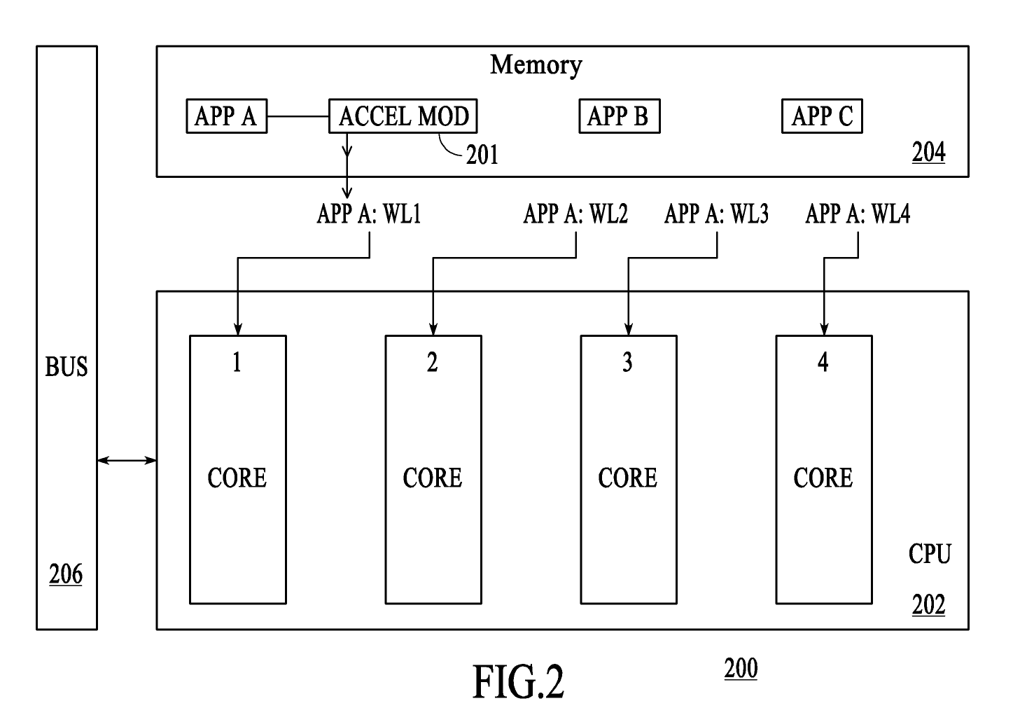

FIG. 2 is a block diagram of a system 200 according to an embodiment. System 200 includes a CPU 202 with multiple cores 1 through 4. In various embodiments CPU 202 could have more or fewer cores. CPU 202 is coupled to a memory subsystem 204, which can include any type of memory that is directly accessible to the CPU 202 for the purpose of accessing and executing application code, managing cache and so on. CPU 202 is coupled to other system components via one or more buses 206 in any typical manner. Memory subsystem 204 stores multiple software applications (also referred to as programs or executables), application A, application B, and application C. Examples of applications include Microsoft (MS) Internet Explorer™, MS Outlook™, and many others. These applications are merely examples. Many more applications can be accessible to the CPU 202. In addition, applications and other executable code are accessible to CPU 202 remotely through bus 206 in some instances.

Memory subsystem 204 also stores an accelerator module 201. Accelerator module 201 modifies application A as further described below. Accelerator module 201 divides the task of application A into workloads that can be assigned to various cores. For example, as shown workload 1 is assigned to core 1, workload 2 is assigned to core 2, workload 3 is assigned to core 3, and workload 4 is assigned to core 4. As further described, workloads are assigned weights. Allocation of workloads to particular cores takes into account the availability of the cores and the workload weights. Therefore, the assignment of workloads to cores could be different than shown in the example.

Although not explicitly shown in FIG. 2, any of the cores could also be working on one of the other applications (B or C) while working on one of the application A workloads.

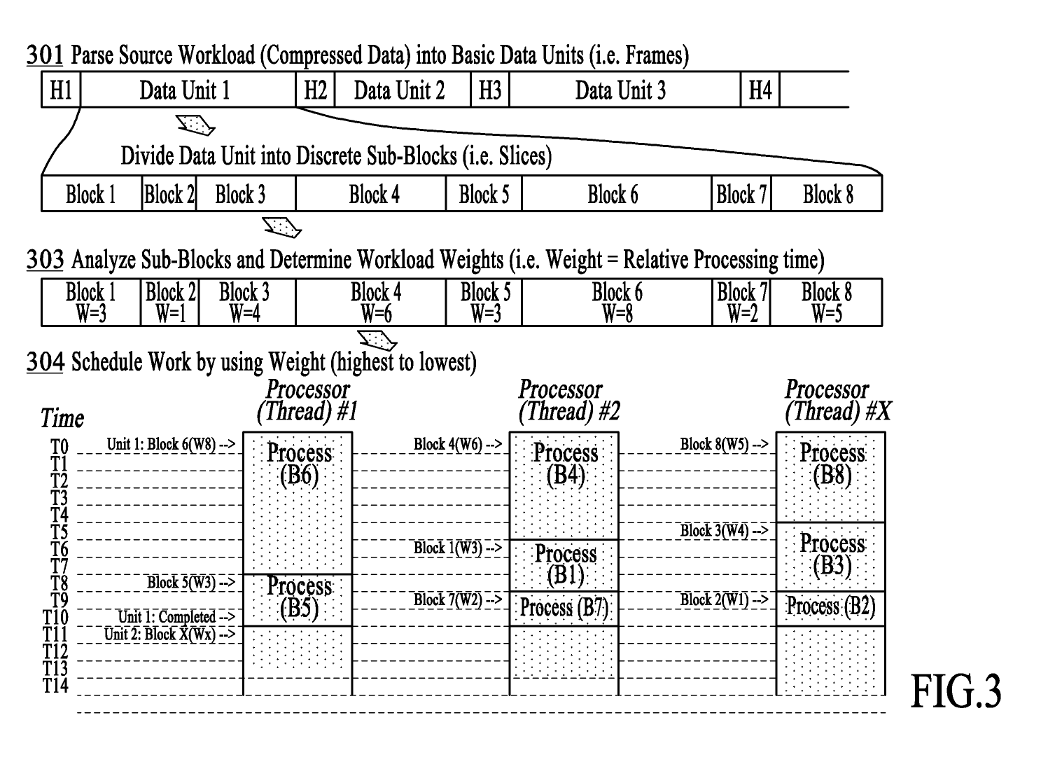

FIG. 3 is a block diagram showing a flow of parsing, weighting and scheduling workloads according to an embodiment. FIG. 3 is an illustration of one example in which the acceleration module 201 operates on a FFMPEG decoding tool. As is known in the art, FFMPEG is a computer program that can record, convert and stream digital audio and video in numerous formats. FFMPEG is a command line tool that is composed of a collection of free software/open source libraries. The name “FFMPEG” comes from the MPEG video standards group, together with “FF” for “fast forward”.

At 301, the source task or workload is parsed into basic data units. In the particular example of FFMPEG the data units can be video frames. The data units are divided into discrete sub-blocks, in this case, data slices. At 303 the sub-blocks are analyzed to determine relative workload weights. In one embodiment, weight is determined by relative processing units per workload.

At 304 workloads are scheduled into cores using weights from highest weight to lowest weight. The executing workloads are assigned to “threads” within various cores (also referred to here as processors) as shown. For example, sub-block 6 with a workload weight of 8 (W8) is assigned first at time t0 (having the highest weight) to thread #1, and so on. As shown at time t8, the workload of sub-block 6 is finished and then the sub-block 3 with the workload weight of 5 (W5) can be assigned to thread #1. Thread #2 and thread #3 are similarly filled.

The following sections provide more detailed information regarding use of the accelerator module for optimizing a video decoder. The following information is just one particular example of optimization of an application for execution on AMD™ Quad-Core systems, such as the AMD™ Opteron processor-based platforms, but embodiments are not so limited. In an embodiment, the accelerator module modifies computer executable code to schedule sequential and parallel tasks across multiple processing cores for optimum performance.

The following is partially based on an analysis of the decoder codec code as provided by the FFMPEG open source community. The following also outlines the improvements demonstrated when running the decoder on a particular AMD platform as well as incremental improvements observed when adding changes specifically to the platform.

The following information outlines the steps taken, the optimization opportunities uncovered, and the results achieved with specific changes on the FFMPEG open source code base for H.264. The performance benchmarks are estimates only and were done with pre-released versions of hardware and software.

Optimizations were achieved in several areas with the H.264 decoder code. The following details focus largely on multi-threading to take advantage of the additional cores that the host platform delivers and taking a close look at various approaches to how to best thread the codec for granularity of data as well as use of the processor affinity feature. Other possible areas of optimization include misaligned data access, but are not so limited.

The steps taken to tune the codec for a particular host AMD platform are outlined below.

Thread Synchronization

The initial effort for optimization was to enable the decoder to be multi-threaded. Since both one and two socket AMD platform processor-based systems were used for this exercise, the systems offered four-core and eight-core configuration that were tuned to enable up to at least eight threads.

The H.264 codec is easily partitionable either at the frame level or at the slice level. The decoder can operate in parallel on either the frame level or, at a finer granularity; e.g., the slice level. Threading was initially performed at the slice level since the code was easily partitioned in that manner by simply making the call to Decode Slice for each thread. In an effort to optimize the H.264 code with threading at the slice level, three separate methods were executed and the results of each were compared. The three methods included:

1. Queue All and Start;

2. Staggered Sequencing; and

3. Weighted Processing.

Each of these gave incremental improvements as detailed below. Also provided below are details on results for efficient synchronization of objects.

Queue All and Start Method

Referring to Table 1, this initial method used to distribute Slice processing to multiple threads (i.e., cores), while not optimal, allowed quick debugging with queuing and synchronization. When fully tuned, each core's utilization did not exceed 50% except for the Main Thread.

TABLE 1

| Main Thread (Thread 0) | Thread 1 | Thread 2 | Thread X |
|---|---|---|---|
| ParseFrameStart(Frame0) | | | |
| ParseSlice(Slice0) | | | |
| QueueSlice(Slice0, Thread0) | | | |
| ParseSlice(Slice1) | | | |
| QueueSlice(Slice1, Thread1) | | | |
| ParseSlice(Slice2) | | | |
| QueueSlice(Slice2, Thread2) | | | |
| ParseSlice(SliceX) | | | |
| QueueSlice(SliceX, ThreadX) | | | |
| ProcessAllQueuedSlices( ) | | | |
| SIGNAL_READY(Thread1 . . . X) | | | |
| DecodeSlice(Slice0) | DecodeSlice(Slice1) | DecodeSlice(Slice2) | DecodeSlice(SliceX) |
| WaitAllQueuedSlices( ) | | | |
| ParseFrameStart(Frame1) | | | |
| . . . | | | |

Staggered Sequencing Method

Referring to Table 2, in this method, the Thread starts processing the Slice data as soon as it has been queued. This increased CPU utilization as Slice decodes have more chance to complete before the “WaitAllQueuedSlices” stage.

TABLE 2

| Main Thread (Thread 0) | Thread 1 | Thread 2 | Thread X |
|---|---|---|---|
| ParseFrameStart(Frame0) | | | |
| ParseSlice(Slice0) | | | |
| QueueSlice(Slice0, Thread0) | | | |
| ParseSlice(Slice1) | | | |
| QueueSlice(Slice1, Thread1) | | | |
| ParseSlice(Slice2) | DecodeSlice(Slice1) | | |
| QueueSlice(Slice2, Thread2) | | | |
| ParseSlice(SliceX) | | DecodeSlice(Slice2) | |
| QueueSlice(SliceX, ThreadX) | | | |
| | | | DecodeSlice(SliceX) |
| DecodeSlice(Slice0) | | | |
| WaitAllQueuedSlices( ) | | | |
| ParseFrameStart(Frame1) | | | |
| . . . | | | |

Weighted Processing Method

Referring to Table 3, examining the idle time of the decode threads, it was found that the test streams included variable processing where the simplest Slice completed up to five times faster than the most difficult. To better keep threads fully (and equally) busy, weights were given to the processing required for each Slice. The weights would be proportional to the compressed input bits that make up the Slice. For example, it was concluded that on average a Slice of size 32 Kb takes about 2 times the processing of a 16 Kb slice. To implement this logic requires a more flexible queue with the following additional features:

1. The Main Thread can freely push Slices to the Queue with no specific dependencies on threads (i.e. no blocking); and

2. The worker threads could pull slices off the queue based on the highest or lowest weight, hence out-of-order.

Having this mechanism allows each worker thread to pull the largest weighted slice from the queue. In this way heavier blocks of work would be executed earlier in the sequence before reaching the “WaitAllQueuedSlices” stage, increasing overall core utilization.

TABLE 3

| Main Thread (Thread 0) | Thread 1 | Thread 2 | Thread X |
|---|---|---|---|
| ParseFrameStart(Frame0) | | | |
| ParseAndQSlice(Slice0, W6) | | | |
| ParseAndQSlice(Slice1, W8) | | | |
| ParseAndQSlice(Slice2, W2) | DecodeSlice(Slice1, | | |
| | W8) | | |
| ParseAndQSlice(Slice3, W9) | | DecodeSlice(Slice0, | |
| | | W6) | |
| ParseAndQSlice(Slice4, W4) | | | DecodeSlice(Slice3, |
| | | | W9) |
| ParseAndQSlice(Slice5, W6) | | | |
| DecodeSlice(Slice5, W6) | | | |
| | | DecodeSlice(Slice4, | |
| | | W4) | |
| | DecodeSlice(Slice2, | | |
| | W2) | | |
| WaitAllQueuedSlices( ) | | | |
| ParseFrameStart(Frame1) | | | |
| . . . | | | |

Slice Level Partitioning versus Frame Level Partitioning

The H.264 decoder code was modified to enable threading on slice boundaries which simply enabled the division of labor into threads within its existing slice processing routine. Alternatively, the processing of the decoder could also have been done at the frame level, thus making the granularity of the individual pieces of work greater. This would work well for utilizing a higher percentage of each of the cores with less overhead for processing. However, it was determined that threads at the frame level would need access to results from other frames in order to perform its work whereas threads at the slice level only require information about the particular frame on which it is operating. Thus, the amount of work required to enable the frame level threading in the existing code may well provide more optimal results. However, it was somewhat outside the scope of this effort given that it would require significantly more re-architecting the current codec than partitioning at the slice level.

Embodiments described herein may be directed to a parallel processor computing environment, such as a system that includes multiple central processing unit (CPU) cores, multiple graphical processing unit (GPU) cores, or a hybrid multi-core CPU/GPU system. Thus, the workload units could be divided off into CPU cores, GPU cores, or any combination of CPU and GPU cores.

Any circuits described herein could be implemented through the control of manufacturing processes and maskworks which would be then used to manufacture the relevant circuitry. Such manufacturing process control and maskwork generation are known to those of ordinary skill in the art and include the storage of computer instructions on computer readable media including, for example, Verilog, VHDL or instructions in other hardware description language.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

The term “processor” as used in the specification and claims includes a processor core or a portion of a processor. Further, although one or more GPUs and one or more CPUs are usually referred to separately herein, in embodiments both a GPU and a CPU are included in a single integrated circuit package or on a single monolithic die. Therefore a single device performs the claimed method in such embodiments.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. The teachings of the disclosure provided herein can be applied to other systems, not only for systems including graphics processing or video processing, as described above. The various operations described may be performed in a very wide variety of architectures and distributed differently than described. In addition, though many configurations are described herein, none are intended to be limiting or exclusive.

The teachings of the disclosure provided herein can be applied to other systems, not only for systems including graphics processing or video processing, as described above. The various operations described may be performed in a very wide variety of architectures and distributed differently than described. In addition, though many configurations are described herein, none are intended to be limiting or exclusive.

In other embodiments, some or all of the hardware and software capability described herein may exist in a printer, a camera, television, a digital versatile disc (DVD) player, a DVR or PVR, a handheld device, a mobile telephone or some other device. The elements and acts of the various embodiments described above can be combined to provide further embodiments. These and other changes can be made to the method and system in light of the above detailed description.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Such computer readable media may store instructions that are to be executed by a computing device (e.g., personal computer, personal digital assistant, PVR, mobile device or the like) or may be instructions (such as, for example, Verilog or a hardware description language) that when executed are designed to create a device (GPU, ASIC, or the like) or software application that when operated performs aspects described above. The claimed invention may be embodied in computer code (e.g., HDL, Verilog, etc.) that is created, stored, synthesized, and used to generate GDSII data (or its equivalent). An ASIC may then be manufactured based on this data.

Accordingly, the inventors reserve the right to add additional claims after filing the application to pursue such additional claim forms for other aspects of the method and system.

What is claimed is:

1. A processing method comprising:
accessing an application program stored in a memory device;
parsing source workload data of the application program into data units;
dividing the data units into sub-blocks;
determining workload weights for each of the sub-blocks; and
scheduling workloads to be performed by a plurality of processors in a multi-processor system based upon workload weights of the sub-blocks, wherein the application program comprises one or more of serial tasks and parallel tasks.

2. The method of claim 1, wherein the multi-processor system comprises multiple similar central processing units.

3. The method of claim 1, wherein the memory device comprises a system memory resident on the multi-processor system.

4. The method of claim 1, wherein the application program comprises a video decoding application program.

5. The method of claim 4, wherein the basic data units comprises video frames.

6. The method of claim 5, wherein the sub-blocks comprises data slices.

7. The method of claim 1, wherein scheduling workloads comprises assigning workloads to threads within a processor.

8. The method of claim 7, wherein the application program comprises a video decoding application, and wherein workloads comprise data slices.

9. The method of claim 8 further comprising synchronizing threads.

10. A computer readable medium having stored thereon instructions to enable manufacture of a circuit comprising:
a plurality of processing cores configured to perform an application task by executing certain operations in parallel in the plurality of processing cores and certain other operations serially within one or more of the plurality of processing cores; and
an accelerator module modifying computer executable instructions of the application task program code to schedule sequential and parallel tasks across the plurality of processing cores by dividing the application task into a plurality of sub-blocks, determining a relative workload weight for each sub-block, and scheduling the sub-blocks for execution in a processing core of the plurality of processing cores depending upon a respective workload weight.

11. The computer readable medium of claim 10, wherein the instructions comprise hardware description language instructions.

12. A computer readable medium having stored thereon instructions that when executed in a processing system, cause a multi-processor method to be performed, the method comprising:
accessing an application program stored in a memory device;
parsing source workload data of the application program into data units;
dividing the data units into sub-blocks;
determining workload weights for each of the sub-blocks; and
scheduling workloads to be performed by a plurality of processors in a multi-processor system based upon workload weights of the sub-blocks, wherein the application program comprises one or more of serial tasks and parallel tasks.

13. The computer readable medium of claim 12, wherein the multi-processor system comprises multiple similar central processing units.

14. The computer readable medium of claim 12, wherein the memory device comprises a system memory resident on the multi-processor system.

15. The computer readable medium of claim 12, wherein the application program comprises a video decoding application program.

16. The computer readable medium of claim 15, wherein the basic data units comprise video frames.

17. The computer readable medium of claim 16, wherein the sub-blocks comprises data slices.

18. The computer readable medium of claim 12, wherein scheduling workloads comprises assigning workloads to threads within a processor.

19. The computer readable medium of claim 18, wherein the application program comprises a video decoding application, and wherein workloads comprise data slices.

20. The computer readable medium of claim 19 further comprising synchronizing threads.

21. A multi-processor computing system comprising:
a plurality of processing cores configured to perform an application task by executing certain operations in parallel in the plurality of processing cores and certain other operations serially within one or more of the plurality of processing cores; and
an accelerator module modifying computer executable instructions of the application task program code to schedule sequential and parallel tasks across the plurality of processing cores by dividing the application task into a plurality of sub-blocks, determining a relative workload weight for each sub-block, and scheduling the sub-blocks for execution in a processing core of the plurality of processing cores depending upon a respective workload weight.

22. The system of claim 21 wherein the plurality of processing cores comprise processor cores within a central processing unit (CPU).

23. The system of claim 21 wherein the plurality of processing cores comprise processor cores within a graphics processing unit (GPU).

24. The system of claim 23 wherein the application task comprises a video decoding application.
